(19) United States
(12) Patent Application Publication
(10) Pub. No.: US 2006/0203015 A1
(43) Pub. Date: Sep. 14, 2006

(54) Image transformation method and device

(75) Inventor: Tsung-Heng Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/252,934

(22) Filed: Oct. 18, 2005

(30) Foreign Application Priority Data
Mar. 10, 2005 (TW) 94107273

(51) Int. Cl. G09G 5/00

(52) U.S. Cl. 345/667

(57) ABSTRACT

An image transformation method is provided, converting an original image to a display image, the original image including a plurality of original lines each including a plurality of pixels. First, the plurality of original lines are selected through a line mask to obtain a plurality of selected lines. The plurality of pixels in the selected lines are selected through a pixel mask to generate a plurality of shortened lines corresponding to the selected lines. Thereafter, the shortened lines are grouped to generate the display image. An image transformation device and a digital recorder apparatus performing the image transformation are also provided.

### BACKGROUND

The invention relates to an image transformation method and device, and in particular, to a programmable transformation method utilized in portable devices such as cameras and digital recorders.

Most current displays for digital cameras are thin film transistor (TFT) devices or low temperature poly silicon (LTPS) devices, from 1.4 inches to 2.0 inches, with resolutions varying from 280×220 to 560×240. Atypical image device generate static images sizing such as 640×480, with dynamic video stream sizing such as 320×240. When displaying the generated image, resolution transformation is required to fit the image on the display. Conventional design implements individual transformation modules for different size displays, which is a costly and inflexible solution.

### SUMMARY

An image transformation method is provided, converting an original image to a display image, the original image including a plurality of original lines, each including a plurality of pixels. First, the original lines are selected through a line mask to obtain a plurality of selected lines. The plurality of pixels in the selected lines is selected through a pixel mask to generate a plurality of shortened lines corresponding to the selected lines. Thereafter, the shortened lines are grouped to create the display image. An image transformation device and a digital recorder apparatus performing the image transformation are also provided.

The line mask and the pixel mask are composed of a plurality of first bits and second bits. When selecting the plurality of original lines through the line mask, lines mapped by the first bit may be preserved, and lines mapped by the second bit discarded. When selecting the plurality of pixels in the selected lines through the pixel mask, pixels mapped by the first bit are kept, and pixels mapped by the second bit are discarded. The line mask and the pixel mask may be programmable.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows an embodiment of an image transformation device according to the invention;

FIG. 2a shows an embodiment of line selection through the line register 202;

FIG. 2b shows an embodiment of pixel selection through the pixel register 201;

FIG. 2c shows an embodiment of the line register 202;

FIG. 2d shows an embodiment of the pixel register 201;

FIG. 2e shows another embodiment of the line register 202;

FIG. 2f shows another embodiment of the pixel register 201;

FIG. 2g shows another embodiment of the line register 202; and

FIG. 3 shows an embodiment of a digital recorder apparatus according to the invention.

### DETAILED DESCRIPTION

A programmable image transformation method and device are provided.

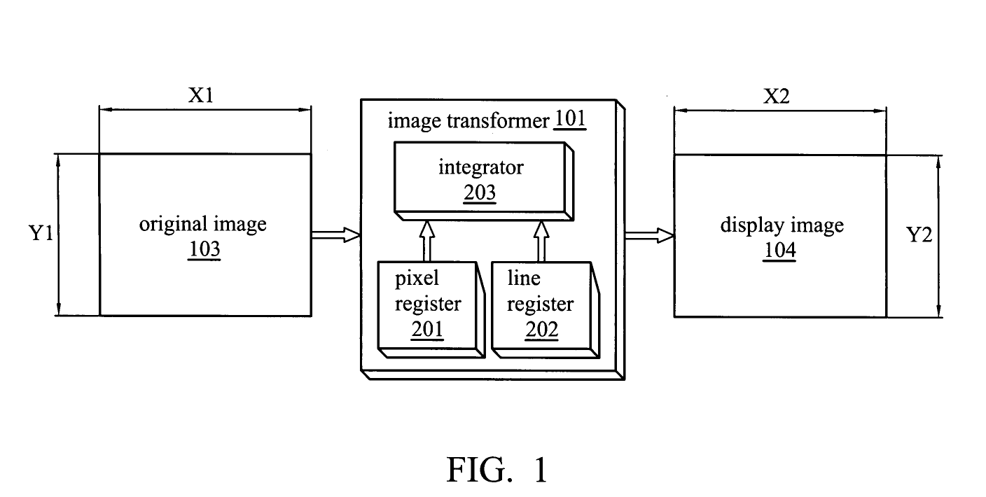

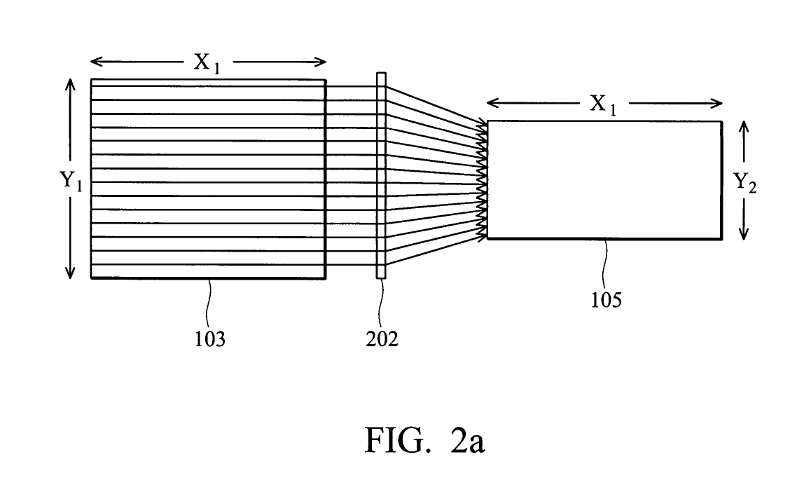

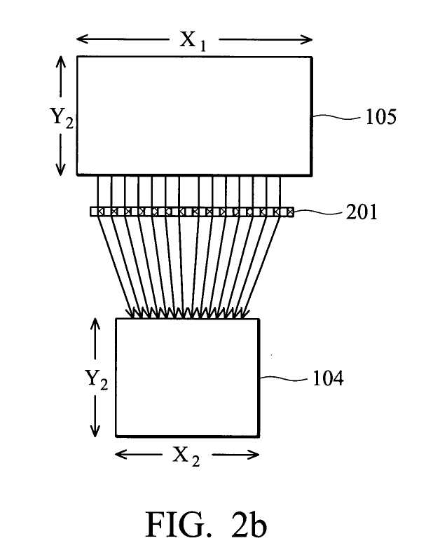

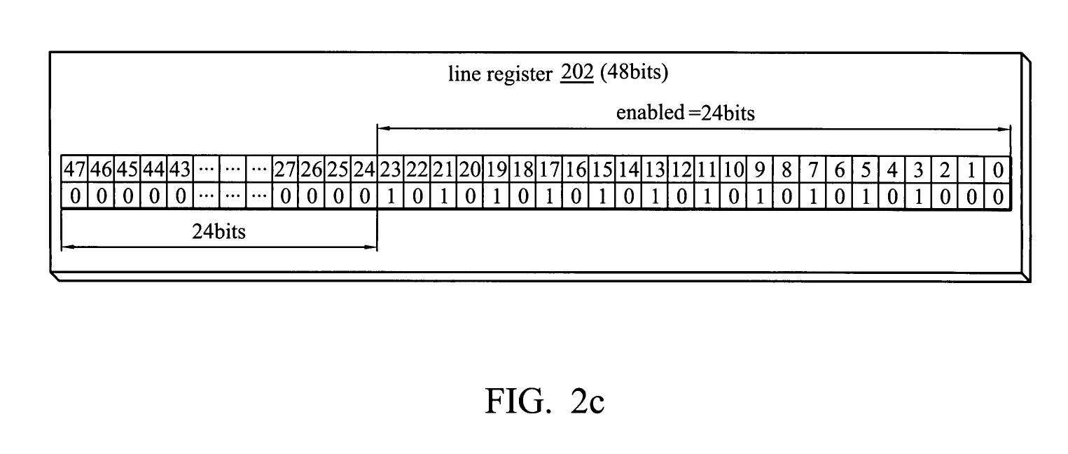

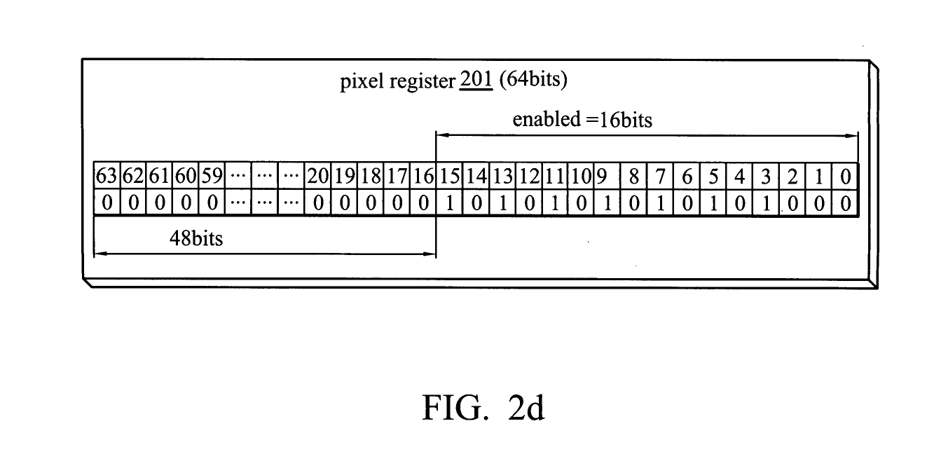

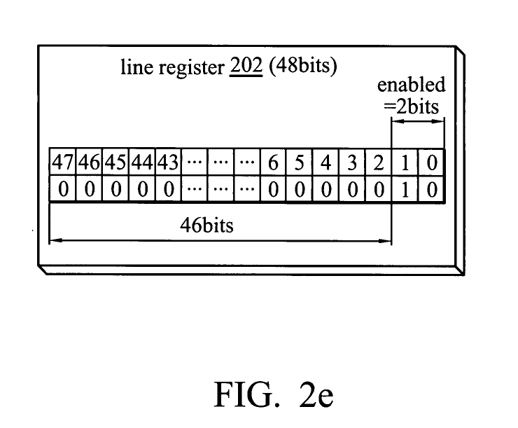

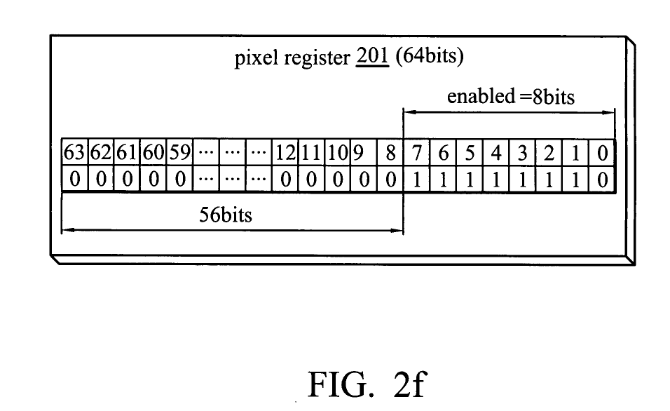

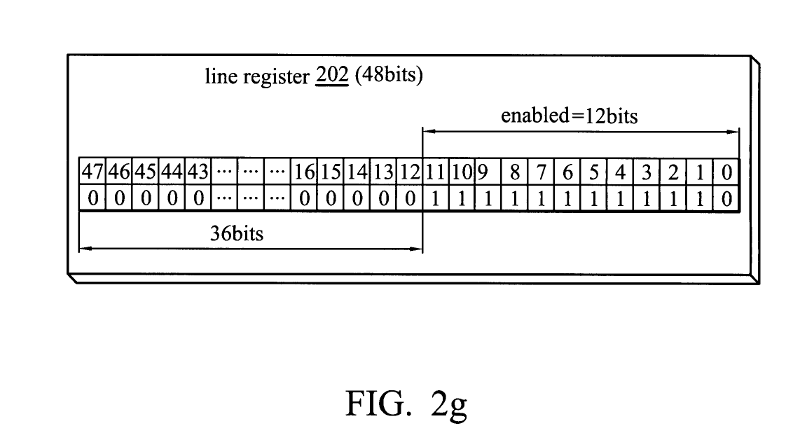

FIG. 1 shows an embodiment of an image transformation device according to the invention. An image transformer 101 includes a pixel register 201, a line register 202, and an integrator 203. Each pixel register 201 and line register 202 includes a mask composed of a plurality of bits, 0 and 1. Patterns in the masks include uniformly distributed bits 0 and 1, as shown in FIG. 2c to 2g. The image transformer 101 performs line selection and pixel selection according to the line register 202 and pixel register 201 for transforming an original image 103 to a display image 104. Lines and pixels in the original image 103 are selected according to the patterns in the masks of the line register 202 and pixel register 201. In FIG. 1, the original image 103 includes Y1 lines, and each line includes X1 pixels.

FIG. 2a shows an embodiment of line selection through the line register 202. The image transformer 101 selects the line register 202 to filter the Y1 lines of original image 103, preserves lines that map to bit 1 in the line register 202 and discards lines that map to bit 0 in the line register 202, such that the Y2 preserved lines are formed an intermediate image 105 by the integrator 203, wherein each preserved line in the intermediate image 105 still includes X1 pixels.

FIG. 2b shows an embodiment of pixel selection through the pixel register 201. The image transformer 101 selects the pixel register 201 to filter the Y2 preserved lines, preserves pixels that map to bit 1 in the pixel register 201 and discards pixels that map to bit 0 in the pixel register 201, such that the total of preserved pixels in the preserved lines are X2. Thereafter, the Y2 preserved lines each including X2 pixels are grouped to generate the display image 104 by the integrator 203. For example, an original image 103 is to be transformed to a display image 104, where the size of the original image 103 is 640×480 and the size of the display image 104 is 280×220. The original image 103 includes 480 lines each including 640 pixels, wherein 220 lines are selected to form the intermediate image 105. Therefore equivalently, 11 lines are to be selected out of every 24 lines. In this case, the line register 202 includes 48 bits, in which 24 bits are enabled to present the 11/24 pattern, while the rest are disabled. FIG. 2c shows the enabled bits aligned to the least significant bit (LSB) side, and 11 “1” bits and 13 “0” bits uniformly distributed therein. The bit arrangement is programmable according to the resize ratio. The image transformer 101 reads the line register 202 to select the 480 lines, selecting 11 lines out of every 24 lines according to the enabled bit pattern of the line register 202. Thereafter, the 220 selected lines form an intermediate image 105, as shown in FIG. 2a.

Similarly, the width of the intermediate image 105 is to be resized. In this case, 280 pixels out of 640 pixels are selected for every selected line in the intermediate image 105. In other words, 7 pixels out of every 16 pixels are selected. The pixel register 201 includes 64 bits, wherein 16 bits are enabled while another 48 bits are disabled and 7 “1” bits with 9 “0” bits are uniformly distributed in the enabled 16 bits. FIG. 2d shows the specific embodiment of the pixel register 201 including a 7/16 pattern. Thereby, the width of the intermediate image 105 is resized from 640 to 280, forming the display image 104 as shown in FIG. 2b.

In another example, an original image 103 transformed to a display image 104 is performed, where the size of the original image 103 is 640×480 and the size of the display image 104 is 560×240. The original image 103 includes 480 lines each includes 640 pixels, and 240 lines in which are selected to generate the intermediate image 105. Equivalently, 1 line is selected out of every 2 lines. In this case, the line register 202 includes 48 bits, of which 2 bits are enabled to present the 1/2 pattern, while the other 46 bits are disabled. FIG. 2e shows the enabled bits aligned to the least significant bit (LSB) side, and a “1” bit and a “0” bit uniformly distributed therein. The bit arrangement is programmable according to the resize ratio. The image transformer 101 reads the line register 202 to select the 480 lines, selecting 1 line out of every 2 lines according to the enabled bit pattern of the line register 202. Thereafter, the 240 selected lines form an intermediate image 105, as shown in FIG. 2a.

Similarly, the width of the intermediate image 105 is to be resized. In this case, 560 pixels out of 640 pixels are selected for every selected line in the intermediate image 105. In other words, 7 pixels out of every 8 pixels are selected. The pixel register 201 includes 64 bits, of which 8 bits are enabled while the other 56 bits are disabled and 7 “1” bits with 1 “0” bit uniformly distributed in the enabled 8 bits. FIG. 2f shows the specific embodiment of the pixel register 201 including a 7/8 pattern. Thereby, the width of the intermediate image 105 is resized from 640 to 560, forming the display image 104 as shown in FIG. 2b.

In another example, an original image 103 transformed to a display image 104 is performed, where the size of the original image 103 is 320×240 and the size of the display image 104 is 280×220. The original image 103 includes 240 lines each including 320 pixels, and 220 lines in which are selected to generate the intermediate image 105. Equivalently, 11 lines are selected out of every 12 lines. In this case, the line register 202 includes 48 bits, of which 12 bits are enabled to present the 11/12 pattern, while the other 36 bits are disabled. FIG. 2g shows the enabled bits aligned to the least significant bit (LSB) side, and 11 “1” bits and one “0” bit uniformly distributed therein. The bit arrangement is programmable according to the resize ratio. The image transformer 101 reads the line register 202 to select the 480 lines, selecting 11 lines out of every 12 lines according to the enabled bit pattern of the line register 202. Thereafter, the 220 selected lines form an intermediate image 105, as shown in FIG. 2a.

Similarly, the width of the intermediate image 105 is to be resized. In this case, 280 pixels out of 320 pixels are selected for every selected line in the intermediate image 105. In other words, 7 pixels out of every 8 pixels are selected. The pixel register 201 includes 64 bits, of which 8 bits are enabled while the other 56 bits are disabled and 7 “1” bits with 1 “0” bit uniformly distributed in the enabled 8 bits. FIG. 2f shows the specific embodiment of the pixel register 201 including a 7/8 pattern. Thereby, the width of the intermediate image 105 is resized from 320 to 280, forming the display image 104 as shown in FIG. 2b.

The selection of the lines and pixels depends on the bit pattern, which is programmable. Thus through flexible adjustment of bit patterns, one image transformation module can be reused for various resolutions without compatibility issues. The original and display height/width is reduced to a common factor (if one exists) to minimize the requirement of bit enablement. For example, the image transformer determines a reduced fraction of the height of the display image over the original image height, such that a numerator H_{d} and a denominator Ho are obtained. Then the image transformer enables Hₒ bits in the line mask and sets H_{d} of the Hₒ enabled bits according to first values, while the remaining Hₒ-H_{d} enabled bits are set according to second values. According to the embodiment in the present invention, the first values are bit “1”, and the second values are bit “0”. Moreover, the line mask comprises x bits, and Hₒ bits are less than x bits, H_{d} bits are less than Hₒ bits.

Similarly, the image transformer determines a reduced fraction of the width of the display image over the original image. width, such that a numerator W_{d} and a denominator Wₒ are obtained. Then the image transformer enables Wₒ bits in the pixel mask and sets W_{d} of the Wₒ enabled bits to first values, while the rest Wₒ-W_{d} enabled bits are set to second values. Similarly, the first values are bit “1”, and the second values are bit “0”. Moreover, the pixel mask comprises y bits, and Wₒ bits are less than y bits, W_{d} bits are less than Wₒ bits.

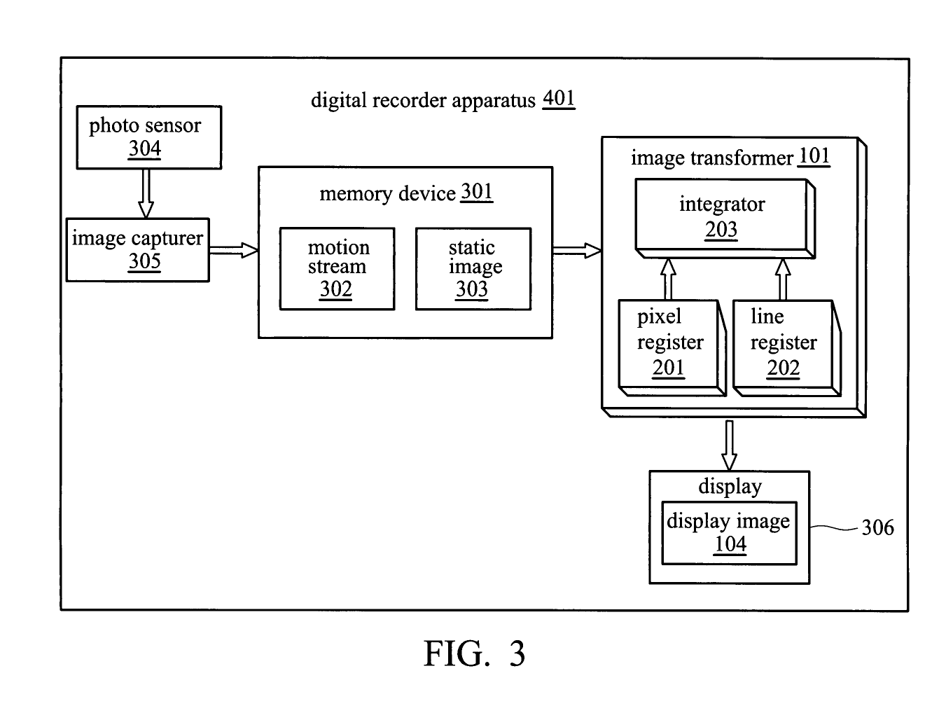

FIG. 3 shows an embodiment of a digital recorder apparatus according to the invention. The digital recorder apparatus 401 can be a digital camera, mobile phone, a recorder, or any portable devices. The digital recorder apparatus 401 includes an image capturer 305, a memory device 301, an image transformer 101 and a display 306. The image capturer 305 captures an original image or film from external sources through a photo sensor 304. The memory device 301 is used for storing the captured original image or captured film (a static image 303 and motion stream 302 as shown in FIG. 3). The image transformer 101 is used for transforming the original image or film to a display image 104 which can be shown on the display 306. The image transformer 101 includes an integrator 203, a line register 202, and a pixel register 201, which are described as above mentioned. The image transformer 101 selects the line register 202 for selecting a plurality of original lines of the original image or film through a line mask to obtain a plurality of selected lines, and selects the pixel register 201 for selecting a plurality of pixels from the selected lines through a pixel mask to generate a plurality of shortened lines corresponding to the selected lines. The integrator 203 then groups the shortened lines to generate the display image 104 to the display 306. The photo sensor 304 is a CCD or CMOS device. The original image 103 stored in the memory device 301 can be a 640×480 motion stream 302 or a 320×240 static image 303 for example. The memory device 301 can be SDRAM, flash memory, or removable storage such as a memory card. The pixel register 201 and line register 202 provide the masks composed of a plurality of bit 0 and 1. The pixel register 201 and line register 202 are programmable, such that the image transformer 101 is reusable for various resolutions.

While the invention has been described by way of example, and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image transformation method applied in portable devices, converting an original image to a display image, wherein the original image comprises a plurality of original lines, each comprising a plurality of pixels, and the image transformation method comprises:
selecting the plurality of original lines through a line mask to obtain a plurality of selected lines;
selecting the plurality of pixels in the selected lines through a pixel mask to generate a plurality of shortened lines from the selected lines; and
grouping the shortened lines to generate the display image.

2. The image transformation method applied in portable devices as claimed in claim 1, wherein:
the line mask and the pixel mask are both formed by a plurality of first bits and second bits.

3. The image transformation method applied in portable devices as claimed in claim 2, wherein the line mask comprises x bits and the pixel mask comprises y bits.

4. The image transformation method applied in portable devices as claimed in claim 3, further comprising:
when selecting the plurality of original lines through the line mask, preserving lines mapped by the first bit and discarding lines mapped by the second bit; and
when selecting the plurality of pixels in the selected lines through the pixel mask, preserving pixels mapped by the first bit and discarding pixels mapped by the second bit.

5. The image transformation method applied in portable devices as claimed in claim 3, wherein the line mask and the pixel mask are programmable.

6. The image transformation method applied in portable devices as claimed in claim 3, further comprising:
determining a reduced fraction of a height of the display image over an original image height to obtain a numerator H_{d} and a denominator Hₒ;
enabling Hₒ bits in the line mask;
setting H_{d} of the Hₒ enabled bits to first values, while the remaining Hₒ-H_{d} enabled bits are second values;
determining a reduced fraction of a width of the display image over an original image width to obtain a numerator W_{d} and a denominator Wₒ;
enabling Wₒ bits in the pixel mask; and
setting W_{d} of the Wₒ enabled bits to first values, while the remaining Wₒ-W_{d} enabled bits are second values.

7. The image transformation method applied in portable devices as claimed in claim 6, wherein:
Hₒ bits are less than x bits, H_{d} bits are less than Hₒ bits; and
Wₒ bits are less than y bits, W_{d} bits are less than Wₒ bits.

8. The image transformation method applied in portable devices as claimed in claim 1, wherein the portable devices comprise digital cameras, digital recorders or communication devices capable of capturing images.

9. An image transformation device applied in a portable apparatus, transforming an original image to a display image, wherein the original image comprises a plurality of original lines, each line comprising a plurality of pixels, the image transformation device comprising:
a line register comprising a line mask, being selected for selecting a plurality of original lines through the line mask to obtain a plurality of selected lines;
a pixel register comprising a pixel mask, being selected for selecting a plurality of pixels in the selected lines through the pixel mask to generate a plurality of shortened lines corresponding to the selected lines; and
an integrator, grouping the shortened lines to generate the display image; wherein
the line mask and the pixel mask are both formed by a plurality of first bits and second bits; and
the line mask comprises x bits and the pixel mask comprises y bits.

10. The image transformation device applied in a portable apparatus as claimed in claim 9, wherein:
when the image transformation device selects the plurality of original lines through the line register, the integrator preserves lines mapped by the first bit and discards lines mapped by the second bit; and
when the image transformation device selects the plurality of pixels from the selected lines through the pixel register, the integrator preserves pixels mapped by the first bit and discards pixels mapped by the second bit.

11. The image transformation device applied in a portable apparatus as claimed in claim 9, wherein the line mask and the pixel mask are programmable.

12. The image transformation device applied in a portable apparatus as claimed in claim 9, wherein:
the image transformation device determines a reduced fraction of a height of the display image over an original image height to obtain a numerator H_{d} and a denominator Hₒ;
the image transformation device enables Ho bits in the line mask;
the image transformation device sets H_{d} of the Hₒ enabled bits to first values, while the remaining Hₒ-H_{d} enabled bits are second values;
the image transformation device determines a reduced fraction of a width of display image over an original image width to obtain a numerator W_{d} and a denominator Wₒ;
the image transformation device enables Wₒ bits in the pixel mask; and
the image transformation device sets W_{d} of the Wₒ enabled bits to first values, while the remaining Wₒ-W_{d} enabled bits are second values.

13. The image transformation method applied in a portable apparatus as claimed in claim 12, wherein:
Hₒ bits are less than x bits, H_{d} bits are less than Hₒ bits; and
Wₒ bits are less than y bits, W_{d} bits are less than Wₒ bits.

14. The image transformation device applied in a portable apparatus as claimed in claim 9, wherein the portable apparatus is a digital camera, a digital recorder, or a communication device capable of capturing images.

15. A digital recorder apparatus capable of transforming an original image comprises:
an image capturer, capturing the original image from external sources;
a memory device, storing the original image;
an image transformer, transforming the original image to a display image, wherein the original image comprises a plurality of original lines, each line comprising a plurality of pixels, comprising:
a line register comprising a line mask, being selected for selecting a plurality of original lines through the line mask to obtain a plurality of selected lines;
a pixel register comprising a pixel mask, being selected for selecting a plurality of pixels in the selected lines through the pixel mask to generate a plurality of shortened lines corresponding to the selected lines; and
an integrator, grouping the shortened lines to generate the display image; wherein
the line mask and the pixel mask are both formed by a plurality of first bits and second bits; and
the line mask comprises x bits and the pixel mask comprises y bits; and
a display, displaying the display image.

16. The digital recorder apparatus as claimed in claim 15, further comprising a photo sensor receiving environmental luminance to provide the original image, wherein the photosensor is a charge coupled device (CCD) or CMOS sensor.

17. The digital recorder apparatus as claimed in claim 15, wherein:
when the image transformer selects the plurality of original lines through the line register, the integrator preserves lines mapped by the first bit and discards lines mapped by the second bit; and
when the image transformer selects the plurality of pixels in the selected lines through the pixel register, the integrator preserves pixels mapped by the first bit and discards pixels mapped by the second bit.

18. The digital recorder apparatus as claimed in claim 15, wherein the line mask and the pixel mask are programmable.

19. The digital recorder apparatus as claimed in claim 15, wherein:
the image transformer determines a reduced fraction of a height of a display image over an original image height to obtain a numerator H_{d} and a denominator Hₒ;
the image transformer enables Hₒ bits in the line mask;
the image transformer sets H_{d} of the Hₒ enabled bits to first values, while the remaining Hₒ-H_{d} enabled bits are second values;
the image transformer determines a reduced fraction of a width of a display image over an original image width to obtain a numerator W_{d} and a denominator Wₒ;
the image transformer enables Wₒ bits in the pixel mask; and
the image transformer sets W_{d} of the Wₒ.enabled bits to first values, while the rest Wₒ-W_{d} enabled bits are second values; wherein
Hₒ bits are less than x bits, H_{d} bits are less than Hₒ bits; and
Wₒ bits are less than y bits, W_{d} bits are less than Wₒ bits.

20. The digital recorder apparatus as claimed in claim 15 being one of a digital camera, a digital recorder and a communication device capable of capturing images.
